(19) United States
(12) Patent Application Publication
(10) Pub. No.: US 2020/0249803 A1
(43) Pub. Date: Aug. 6, 2020

(54) Three-Column Data Interface for Small Devices

(71) Applicant: Rutland Eye Physicians, LLC, Rutland, VT (US)

(72) Inventor: Eitan Sobel, Rutland, VT (US)

(73) Assignee: Rutland Eye Physicians, LLC, Rutland, VT (US)

(21) Appl. No.: 16/267,601

(22) Filed: Feb. 5, 2019

(51) Int. Cl. G06F 3/0482; G06F 16/22; G06F 16/248; G06F 16/9035

(52) U.S. Cl. CPC G06F 3/0482; G06F 16/9035; G06F 16/248; G06F 16/221

(57) ABSTRACT

A system and method both provide a three-column data display for devices with smaller user interfaces, such as tablet and smart phone devices. The data presented includes detail data along with, preferably, three categories of related data. The three-column display locates the detail data on the right-most third column. A selected primary category of data is presented in the left-most first column. User interface elements allow for the selection of the second or third category of data to be presented in the middle second column. The selection of records in the first and second column changes the filter applied to the detail records in the third column, such that only detail records are displayed that are related to the selected first and second column records.

### FIELD OF THE INVENTION

This invention relates to an improved user interface specifically designed to meet the space limitations of smaller devices when reviewing multiple related records in a computerized database.

### BACKGROUND OF THE INVENTION

Computerized databases are extremely helpful for storing and analyzing data. Modern databases establish relationships between different types of data, either by relating tables of different data types in a relational database, or by establishing relationships between classes in an object-oriented environment. Once populated, it can be difficult for users to identify a subset of the data for review and analysis. It is usually necessary to identify values for related database fields in order to identify desired data, but it is difficult to specify these values using the limited confines of a mobile device interface in a manner that does not confuse users.

The usual approach to this problem is to simplify the user interface, such as by flattening related data entities into a single table. For instance, a database that links patients and healthcare providers with medical updates/notes could be turned into a flat database table. The data could be then be presented using a spreadsheet-type layout, such as that provided by Excel (Microsoft Corp., Redmond, Wash.). Each row in the table could be associated with a single patient. Columns could be created for each provider seeing that patient. The cells that link a patient with a provider could contain the notes or updates created by that provider for that patient. Filtering could even be provided so that only a subset of all patient rows are shown at a particular time.

Unfortunately, presenting this data in such a spreadsheet/table format creates a large and unwieldy interface for the user. While it can be satisfactory to display such a view on a large computer display, implementations of a spreadsheet view on the display of a mobile device, such as a tablet or a smart phone, is fraught with difficulties. Users are unable to easily see all the relevant data, are forced to view irrelevant data that is not currently of interest, and the filtering process is complex and burdensome.

The embodiments of the present invention described below overcome these limitations with prior art user interface, simplify the process for selecting filters for the data, and display only relevant data to the user.

### SUMMARY

The present invention utilizes a three-column display to automatically identify and filter data so that only data which is currently of interest to the user is displayed. This invention is ideally suited for the display of data on devices with smaller user interfaces, such as tablet and smart phone devices.

The disclosed embodiments are ideally situated to handle the presentation of a particular type of detail data. The detail data is typically found in a particular database entity, such as a table or a data object. The detail data is related to other related records containing different types of data. Since these records help to identify relevant detailed data, the related records are referred to as categories. Many of the embodiments described herein anticipate at least three related category data entities being associated with the detail data. As an example, medical data may contain detail records relating to medical updates about a patient. The detail updates records are related to patient records (whose healthcare the update records describe), caregiver records (health professionals that wrote the updates), and medical conditions (about which the updates are written). Such data would then have detail data (the updates), and at least three types of category data (patients, caregivers, and medical conditions).

The disclosed embodiments divide the mobile device interface display primarily into three columns. The third or right-most column in the display presents the detail data (such as the medical updates). Each of the first two columns show one of the related categories. One of the related categories is typically selected to constitute the first column in the display. In some embodiments, the user can select which category appears first. In other embodiments, a single category (such as the patient records) always appears in the first column. If a user selects a record from the first column, the detail data in the third column will be filtered to show only detail records related to the selected record in the first column.

The second column will contain records from one of the other two related category database entities. A user interface element allows the user to select which of the two remaining categories is displayed in the second column. Once selected, the second column will display records from the selected (second) category database entity. A user may select one of these records, which will cause the detail records in the third column to be filtered to include only records associated with the selected second category record as well as the selected first category record. An interface element allows the user to remove the filter related to the first category record, meaning that the detail records are filtered only against the selected second category record.

The detail data (such as the medical update) can be considered to represent the cell of a spreadsheet. In this context, the first category data (such as the identity of a patient) can be considered a row heading, with the second category data (the caregiver) being considered the column heading. Unlike a spreadsheet, the present invention is able to handle multiple cell values at the intersection of a row and column (the caregiver can provide multiple medical updates for a particular patient). As these detail records can be added to the data over time, this can be considered to add a time dimension to the data that would otherwise be contained in a spreadsheet.

### BRIEF DESCRIPTION OF THE DRAWINGS

FIG. 1 is a schematic view of a system that implements an embodiment of the present invention.

FIG. 2 is a data graph of generic data that can utilize an embodiment of the present invention.

FIG. 3 is a data graph of medical data having the same structure as that shown in FIG. 2.

FIG. 4 is a data graph of legal data having the same structure as that shown in FIG. 2.

FIG. 5 is a schematic view of a user interface showing detail records for a particular first category record.

FIG. 6 is a schematic view of the user interface of FIG. 5 showing detail records for a particular first category record and a particular second category parent record.

FIG. 7 is a schematic view of the user interface of FIG. 5 showing detail records for a particular first category record and a particular second category child record.

FIG. 8 is a schematic view of the user interface of FIG. 5 showing detail records for the particular second category child record selected in FIG. 7.

FIG. 9 is a schematic view of the user interface of FIG. 5 showing detail records for a particular first category record and a particular third category record.

FIG. 10 is a schematic view of the user interface of FIG. 5 showing detail records for the particular third category record selected in FIG. 9.

FIG. 11 is a schematic view of an alternative user interface showing detail records for the particular third category record selected in FIG. 9 while identifying first category records associated with the detail records.

FIG. 12 is a schematic view of the records of FIG. 11 using an alternative selector interface element to select between the display of second and third category records.

FIG. 13 is a schematic view of the user interface similar to FIG. 7 utilizing the medical data of FIG. 3.

FIG. 14 is a schematic view of the user interface similar to FIG. 9 utilizing the medical data of FIG. 3.

FIG. 15 is a schematic view of the user interface similar to FIG. 7 utilizing the legal data of FIG. 4.

FIG. 16 is a schematic view of an alternative user interface showing three adjacent columns.

FIG. 17 is a schematic view of the alternative user interface showing all detail records associated with kidney stones and identifying the count of records associated with each first category record.

FIG. 18 is a schematic view of an alternative user interface in which the first category in the left-hand column is replaced with the third category.

FIG. 19 is a schematic view of enlarged view of a selected detail record.

FIG. 20 is a schematic view of a user interface providing a view to messaging associated with first category records.

FIG. 21 is a data graph of medical data having a modified structure compared to that shown in FIG. 2.

FIG. 22 is a schematic view of an alternative user interface in which the multiple detail records are expanded.

FIG. 23 is a schematic view of an alternative interface having four columns.

FIG. 24 is a flow chart showing a method for presenting data organized as shown in FIG. 2.

FIG. 25 is a partial flow chart for portion A of FIG. 21.

FIG. 26 is a partial flow chart for portion B of FIG. 21.

FIG. 27 is a schematic view of a traditional spreadsheet representing the data displayed in the present invention.

### DETAILED DESCRIPTION

### System 10

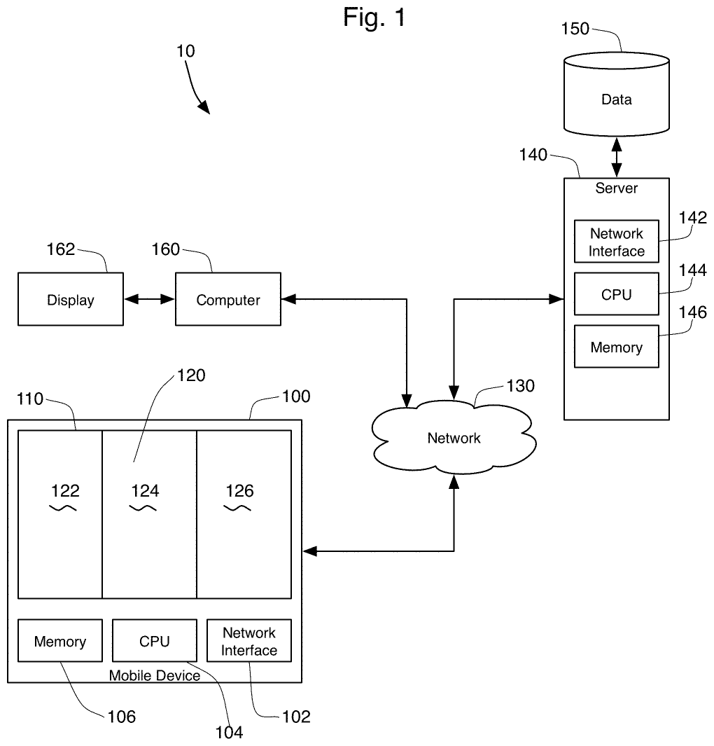

FIG. 1 shows a system 10 in which a mobile device 100 presents a three-column user interface 120 for viewing data. In the embodiment shown in FIG. 1, the data is obtained by the mobile device 100 through a server 140 accessed over a network 130. The network 130 may be a local area network (LAN) or a wide area network (WAN), such as the Internet. Both the mobile device 100 and the server 140 are computing devices, both having a network interface 102, 142 for communicating over the network 130, a CPU 104, 144 for processing commands and manipulating data, and a memory 106, 146 for storing programming and data. The mobile device 100 likely will utilize a RISC processor for CPU 104, such as those designed according to the plans of Arm Holdings PLC of Cambridge, England. These processors 104 will generally operate a mobile device user interface, such as iOS from Apple Inc. (Cupertino, Calif.), Android from Google LLC (Mountain View, Calif.), or Windows 10 Mobile from Microsoft Corp. (Redmond, Wash.). In contrast, the server 140 will likely operate a x86 architecture processor 144 available, for example, from Intel Corp. (Santa Clara, Calif.) and Advanced Micro Devices, Inc. (Sunnyvale, Calif.). With each type of device 100, 140, the processors 104, 144 use programming instructions stored in memory 106, 146 to communicate to each other, to analyze and process data, and to develop user interfaces for display to users.

While the user interface 120 is found on a physical display 110 of the mobile device 100, this does not mean that only the CPU 104 of the mobile device 100 is responsible for presenting this user interface 120. In many cases, the server 140 will generate the primary features of user interface 120, and then present those interface features to the remote mobile device 100. For example, the mobile device 100 may be operating a web browser, and the server 140 creates the interface 120 by generating a web page for display on the browser. In other cases, the mobile device 100 may be operating a specific application (or “app”) that accepts data from the server 140. In these cases, the app operating on the CPU 104 of the mobile device 100 may be fully responsible for generating the user interface 120, while in other cases the app will simply accept and present the user interface 120 generated by the server 140.

The user interface 120 is shown in FIG. 1 as having three columns 122, 124, and 126. While other user interfaces have utilized three columns in order to present data to a user, the present interface 120 is fundamentally different as shown in the description below. This interface 120 is ideally designed for mobile devices 100, such as smart phones and tablet computers. These types of mobile devices 100 have a limited size display screen 110, and therefore are particularly in need of the benefits provided by this interface 120. Of course, the interface 120 could also be used by traditional computers, such as computer 160, that are able to provide a larger-sized display 162 for presenting the interface 120.

The server 140 analyzes and presents data to the mobile device 100 (and computer 160). This data is generally stored in a database 150. This database can be internal to the server 140, can be stored locally while still being managed by the server 140, can be stored remotely and managed by the server 140, or can be stored and managed by a computer that is distinct from the server 140. What is important is that the server 140 can access and manipulate the data 150, and then present this data over the network 130 to the end user devices 100, 160.

In other embodiments (not shown), the data 150 can be stored in the memory 106 of the mobile device 100. In these embodiments, the mobile device 100 will not need to access a remote server 140 over a network 130 in order to generate the user interface 120.

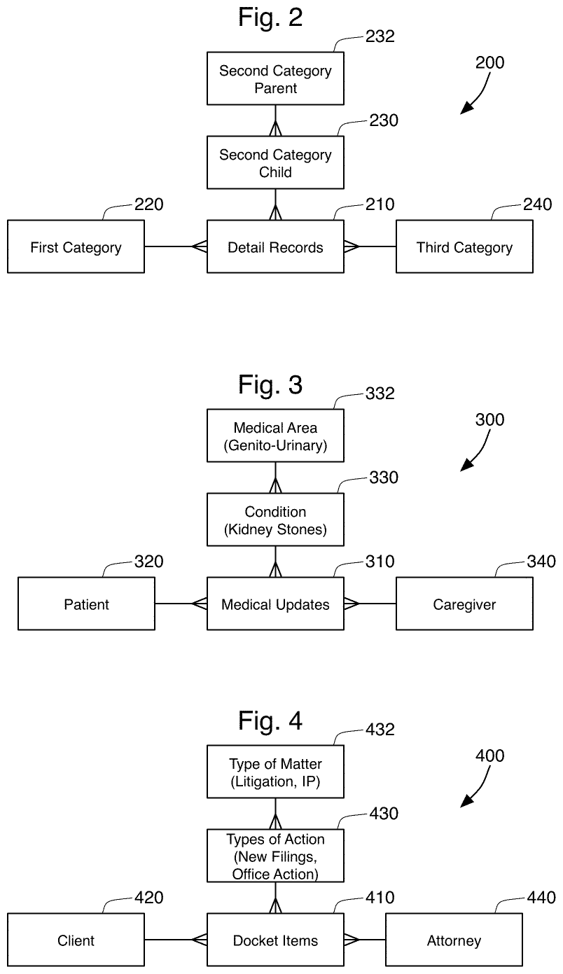

The data 150 can be structured and stored as a traditional relational database, as an object-oriented database, or as a key-value data store. Regardless of its implementation, the data 150 of FIG. 1 is preferably internally structured in a manner similar to that shown in data organization 200 shown in FIG. 2. This data organization 200 shows relationships between separate data entities 210, 220, 230, 232, 240 using crows-foot notation. These entities 210-240 might constitute data tables in a relational database, data objects in an object-oriented framework, or key-value pairs. For ease in discussing this data 150, these entities will generally be referred to as data tables or data records. Note that each table 210-240 will actually contain many data records. Nonetheless, in describing the relationship between data entities 210-240, this description may refer to each individual record using the figure number (210-240) of the entire table.

According to the notation shown in FIG. 2, the detail records 210 are each associated with a single first category record 220 and a single third category record 240, while the first and third category records 220, 240 can each be associated with multiple detail records 210. Similarly, the detail records 210 are each associated with a single second category child 230, which in turn is each associated with a single second category parent 232. The child-parent relationship is commonly used to establish hierarchies in data. Although only the second category data 230, 232 is shown in this type of hierarchical structure, any of the categories of data 220, 230, 240 could be organized into a similar hierarchy. Similarly, even though only two levels of the hierarchy are shown in FIG. 2, it is possible to have multiple levels in this hierarchy, including grandparents, great-grandparents, etc. In addition, although the detail records 210 are shown in FIG. 2 as being associated with only a single record in the three category tables 220, 230/232, 240, this is not a requirement of the present invention. While it is important that each record in the three category tables 220, 230/232, 240 is capable of being associated with multiple detail records 210, it is possible that a single detail record 210 is associated with multiple records in a single category table 220, 230/232, 240.

This data organization 200, with a detail record 210 being associated with three different category records 220, 230, 240, is a common situation in databases. The user interfaces described below apply primarily in these types of data organizations 200. Note that some embodiments of the present invention only require two different categories of data (such as 220, 240) to be associated with the detail record 210. A data organization 200 with the detail records 210 being associated with only two categories 220, 240 can easily be flattened into a spreadsheet, with rows representing one category 220 and columns the other 240, and with the detail records 210 being found in the intersecting spreadsheet cells. Similarly, this type of situation could be represented by a non-relational database table with each row in the spreadsheet being a record in the database and each column being a different field. Of course, the limitation inherent in flat databases and spreadsheet is that it is not possible to have multiple, separate detail records associated with the same two category values—it is difficult or impossible to have multiple cells at the same intersection of column and row, or separate values for a single record and single field.

To better understand this organization 200, FIGS. 3 and 4 present similar data organizations 300, 400. In FIG. 3, data organization 300 relates to medical data. The detail record 210 constitutes a medical update 310—information entered by a medical caregiver about a patient relating to the patient's medical condition. The categories for the medical update detail records 310 are therefore the patient 320 about whom the update is written, the medical condition 330 about which the update is provided, and the professional caregiver 340 that wrote the update 310. Each medical condition 330 can be grouped together into separate medical areas 332, which therefore constitutes the parent category 330 for the medical condition 330.

Similarly, data organization 400 relates to legal data. In this case, a user may be interested in viewing docket deadlines for legal matters. The detail records 410 therefore relate to these docket items. Each docket item 410 relates to a particular client 420, is directed to a particular attorney 440, and relates to a specific type of action to be performed 430. In data organization, the type of action 430 can be grouped into a more generic type of matter 432, which constitutes a parent record 432. The type of matter 432 may be, for instance, a litigation matter or an intellectual property matter (such as a patent application matter). The type of action 430 for a patent application may include new patent filings or the need to respond to an office action.

Note that the client category 420 could also be grouped hierarchically. Instead of identifying only a particular client 420 related to the detail/docket item 410, the detail/docket item 410 could relate to a particular matter or matter number, which could then be grouped by a parent client record. In addition, it is possible that a single docket item 410 could be associated with multiple attorneys 440, as multiple attorneys 440 may be responsible for completing that docket item 410.

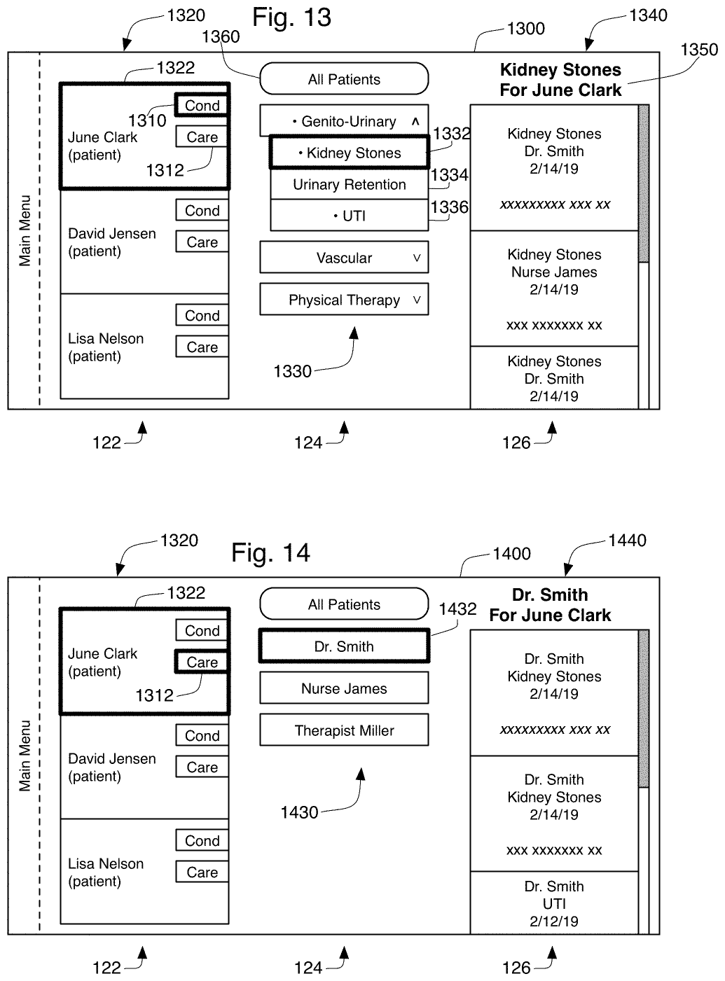

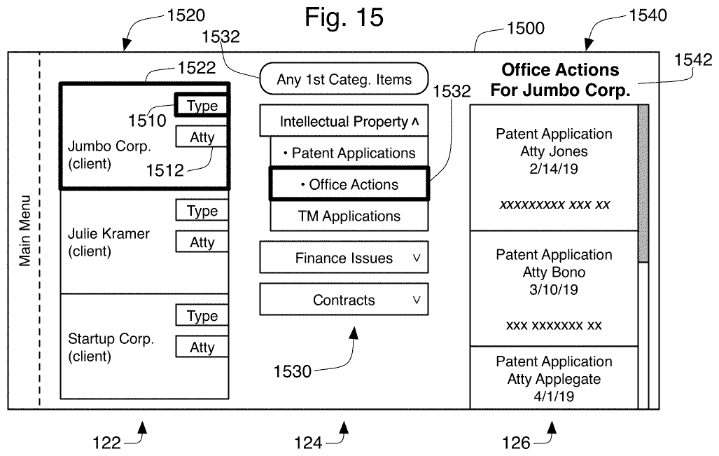

Data organizations 300, 400 are mere examples of the generic data organization 200 shown in FIG. 2. Most of the following descriptions will relate to the generic data organization 200, with only FIGS. 13, 14, 16, and 17 referring back to the medical data organization 300 of FIG. 3, and only FIG. 15 referring back to the legal data organization 400 of FIG. 4.

### User Interface

FIG. 5 shows a user interface 500 containing the three columns shown in FIG. 1 on interface 120, namely, a first or left column 122, a second or middle column 124, and a third or right column 126. As a general matter, the user interface 120 in the disclosed embodiments will present detail records in the third or right column 126. From a conceptual level, the user of interface 500 is primarily interested in the information found in the detail records 560, which are found in the third column 126. The first two columns 122, 124 are used to identify which detail records 560 are displayed in the third column 126. If the medical data organization 300 were being used, the third column 126 would contain the medical updates 310, the first column might be used to select a particular patient 320, while the second column would allow the selection of a medical condition 330 or a caregiver 340 that wrote the update 310. Similarly, if the legal data organization 400 were being used, the right column would identify the docket item 410, the left column 122 would be used to narrow the displayed docket items 410 to particular clients 420, and the middle column 124 would be used to select docket items 410 for a specific type of action 430 or for individual attorneys 440.

It is generally preferred that one of the three categories of data 220, 230, 240 be consistently found in the first column 122. In FIG. 5, the first column displays records 520 from the first category 220. These records 520 are displayed in a vertical column, each record being displayed just below the previous record. In FIG. 5, these records 520 show numerical values 1, 2, and 3, indicating that the mobile device display 110 is showing the first three first category records 220. The scroll bar 524 attached to the records 520 in column 1 is used to scroll through more records 520. In the latter figures below, this scroll bar 524 is removed to simplify the figures. Three detail records 560 are also shown in interface 500. Additional detail records 560 can be viewed by manipulating the scroll bar 562 that is adjacent to those records 560.

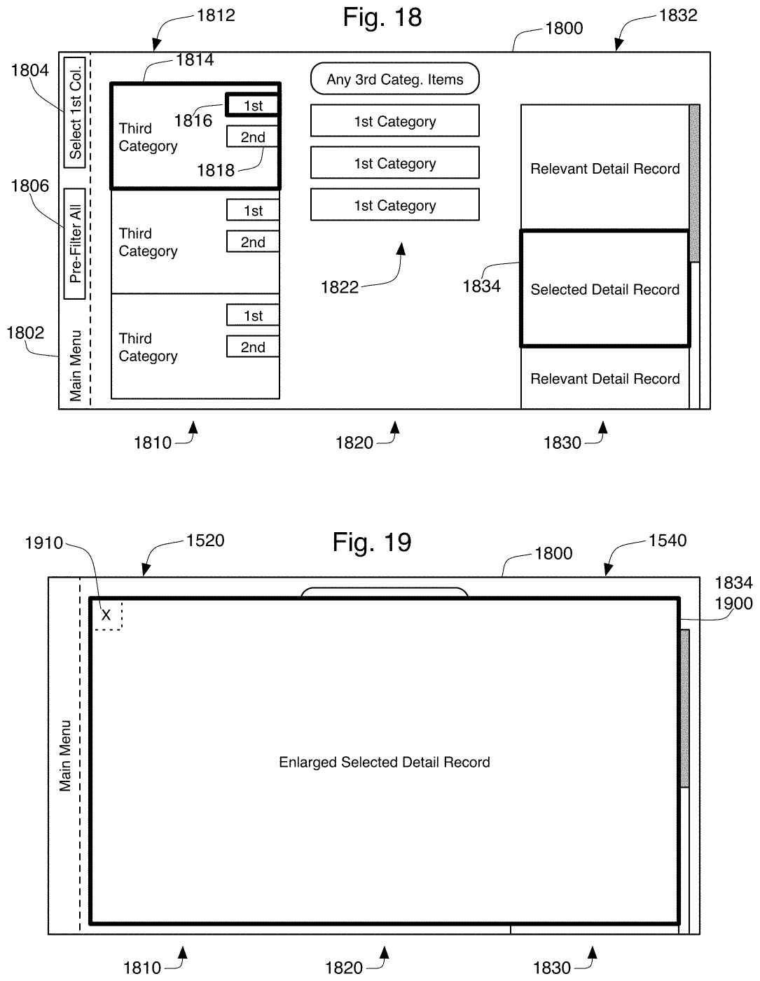

The placement of the first category records 520 in the first column 122 could be a default or preference setting. In one embodiment, the main menu 510 portion of the interface 120 could be accessed to alter the selection of which category of data 220, 230/232, 240 should appear in the first column 122. This is described in more detail below in connection with FIG. 18.

The first of the first category records 522 in FIG. 5 has a bolded box outline, indicating that this record has been selected. The record could be selected by an individual pressing on the record 522 in the interface 120. “Pressing” could occur by pressing on the record using a touchscreen 110, or by manipulating a cursor and selecting the record 522 using a more traditional computer user interface. The selection of the first record 522 causes the list of detailed records 560 to be filtered according to the selected record 522. In other words, only detailed records 560 are shown in the third column 126 that are related to the selected first category record 522 in the data 150 (using the relationships shown in data organization 200). If the user wishes to view records for another patient, the user would scroll through the records 520 using the scroll bar 524 until the desired patient record is seen, and then select that record. Upon such selection, the displayed detailed records 560 will be updated to contain only detail records 560 that are associated with the newly selected first category record. While not shown, it is also possible to allow a user to select multiple first column records simultaneously, in which case the third column 126 would contain only detailed records 560 that are related to one of the multiple first column records.

In one embodiment, the first record 522 in the first column 122 is automatically selected when the user opens this screen 500. In another embodiment, no first category records 520 are selected when the screen 500 is first displayed. In this case, no first category record 520 is selected upon which to filter the detailed records 560, meaning that the third column 126 will contain all of the records in the detail records database entity 210.

It is possible to sort the data presented in any of the columns 122, 124, 126. This can be accomplished by providing sort buttons (not shown) associated with each of the columns 122, 124, 126. Alternatively, the ability to sort columns 122, 124, 126 can be provided through the main menu 510. The main menu 510 is shown on the left hand edge of the interface 120, although the menu could be presented along any edge of the interface 500. The menu 510 itself might use text or icons to select sub menus that slide from the edge of the interface 500 to allow a user to select between different functions and preferences.

The second column 124 in FIG. 5 is shown with records 540 from the second category parent 232 database entity. These records 540 are shown in dashed lines, because none of these records 540 are being used to filter the detail records 560 being displayed in the third column 126. In fact, the interface 120 shown in FIG. 5 might be considered cleaner if no records were displayed in the second column 124 (at least until the user selects which category to place into this column 124, as described in the following paragraph). It would then be clear that all of the detail records 560 being shown in the third column 126 are related to the selected first category record 522, and no other filter is being applied to the third column 126.

Interface 500 also includes interface elements 542 and 544 to select whether the second category records 230/232 or the third category records 240 should be placed into the second column 124. Once one of these elements 542, 544 is selected (or pressed if the interface elements take the form of GUI buttons), the records from the selected category 230/232, 240 are placed into the second column 124 and are made available for further filtering of the detailed records 560. Selecting the first interface element 542 will select the second category records 230/232 for the second column 124, while the other interface element 544 will select the third category records 240.

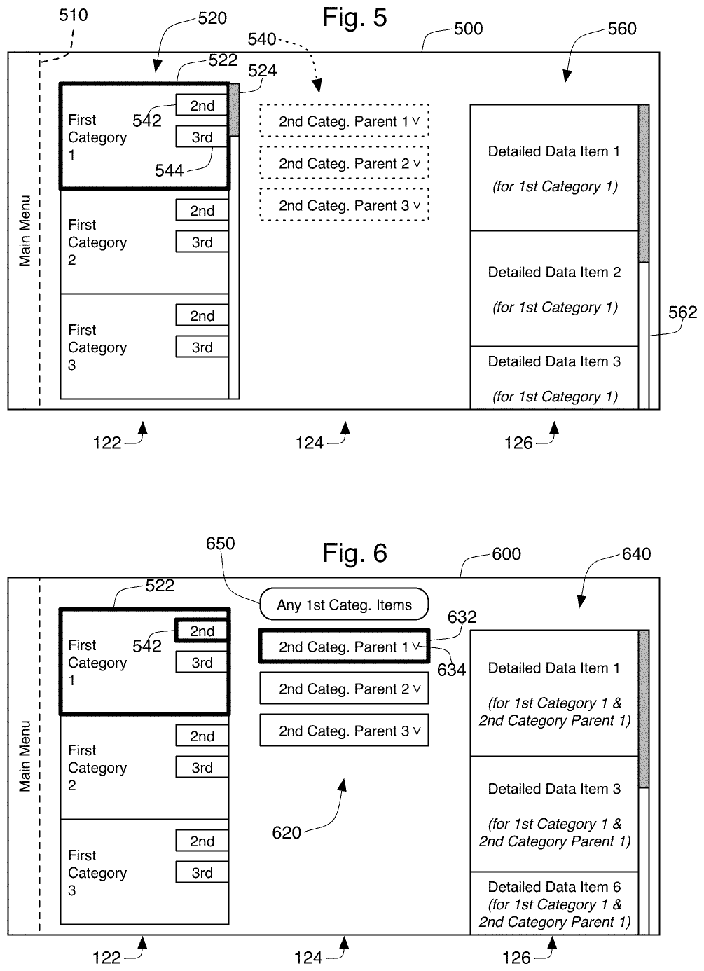

If element 542 is selected, interface 600 of FIG. 6 may be displayed. In this figure, interface element 542 is shown in bold outline, to indicate that it has been selected. The second column 124 now contains records 620 from the second category parent database entity 232. Three of these records 620 are shown in FIG. 6, with the first 632 being shown in bold outline to indicate that it has been selected. The selection of a particular record 632 in the second column 124 indicates that the detailed records 640 now being shown in the third column 126 are being filtered against this record 632 as well as the selected first category record 522. In other words, the detail records 640 shown in interface 600 are those detail records 210 that are associated with the selected first category record 522 and the selected second category parent record 632 (using the relationships shown in data organization 200). Note that data organization 200 shows that detail records 210 are related directly only to the second category child 230, and the relationship between the detail records 210 and the second category parent records 232 is an indirect association. Such indirect associations are sufficient for the selection and filtering described herein.

At the top of the second column 124 in interface 600 is a button 650 labeled “Any 1st Categ. Items.” As explained immediately above, the selection of item 632 causes the list of detailed data items 640 to be filtered both against selected item 632 as well as the selected first category record 522. Pressing this button 650 removes the selected first category record 522 from the filter. In other words, the list of detailed data items 640 will include detail records 210 associated with any of the first category records 220. This is shown and described below in connection with FIG. 8.

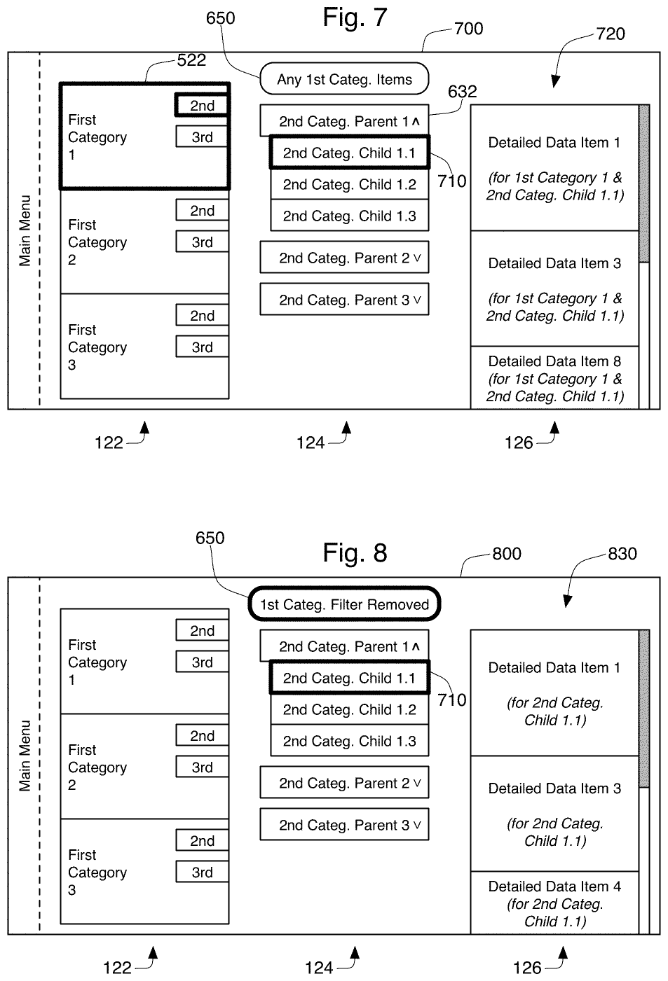

Each of the parent items 620 in the second column 124 include a carat 634 indicating that child records 230 can be viewed for this parent record 232. If the carat 634 for the selected second category parent record 632 is selected, the interface 700 of FIG. 7 is displayed. In this interface, the child records 230 for the selected record 632 are displayed. In interface 700, the first of the child records 710 is selected (bolded). The selection of this record 710 causes the list of detailed records 720 to be filtered against only this child record 710 and not the parent record 632.

The detailed records 720 displayed in interface 700 will continue to be filtered against the selected first category record 522—at least until button 650 is pressed or selected. Once selected, this button 650 will generate interface 800 shown in FIG. 8. In this interface 800, button 650 is highlighted (bolded) to provide feedback of the selection. The text on the button 650 can change to indicate this status change, or to indicate the effect of selecting this button 650 again. The original selection of button 650 caused the displayed list 830 of detail data records 210 to be altered again. In this interface 800, these records 210 are filtered only against the selected second category child record 710, with no filter based on first category records in the first column 122.

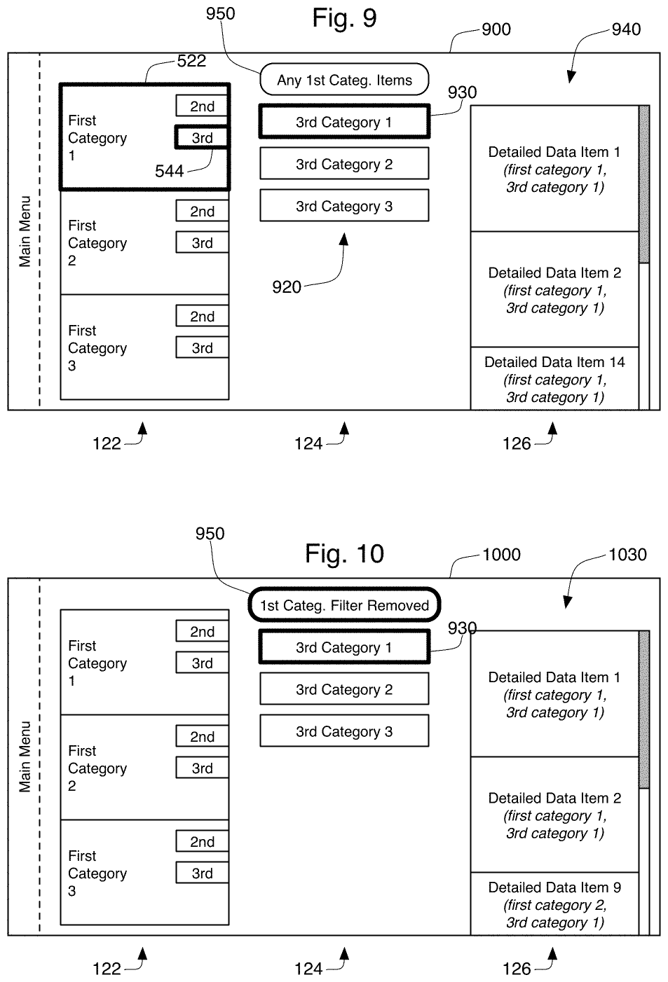

FIG. 9 shows interface 900 that results from the selection of user interface element 544 in FIG. 5. FIG. 9 shows three such data items 920 in the second column 124, with the first third category item 930 being selected. This means that the detail data items 940 shown in the third column 126 are now filtered against the selected third category item 930 as well as the previously selected first category item 522.

Interface 900 includes button 950, which allows the user to remove any filtering against the first category items in the first column 122. If this button is selected, interface 1000 of FIG. 10 is displayed. In this interface 1000, no first category items 220 are shown as selected, and the list of detail data items 1030 in the third column 126 is filtered only against the selected third category item 930.

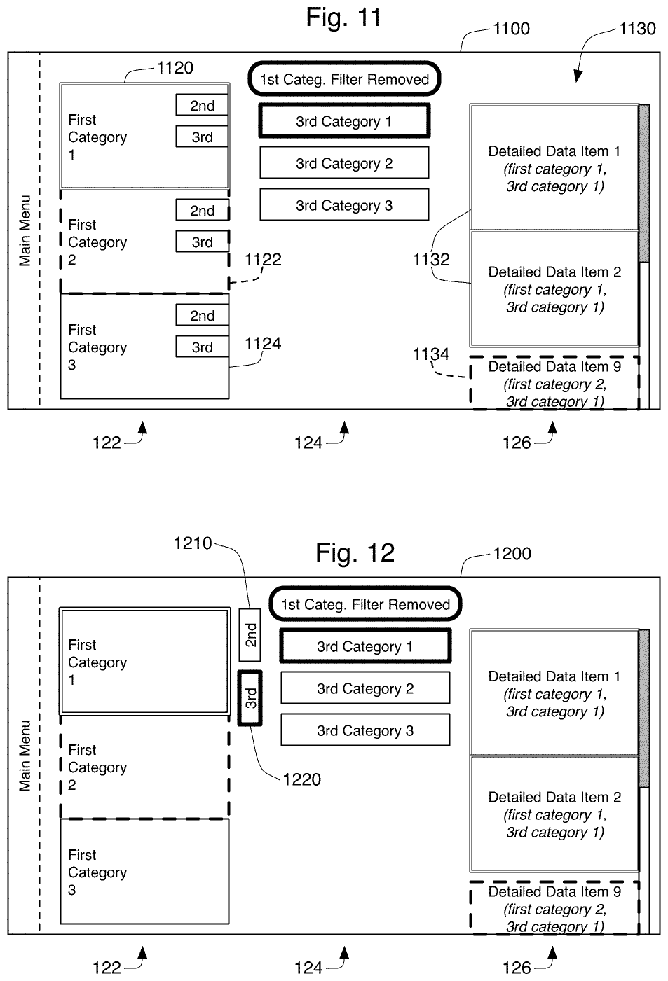

FIG. 11 shows an alternative interface 1100 to interface 1000. In this interface 1100, the first category items 1120 in the first column 122 are altered to indicate which of these items are associated with the displayed detail items 1130. For example, the first two detail data items 1132 in FIG. 11 are distinguished using a double-line border. These two detail data items 1132 are associated with the first of the first category data items 1120 in the first column, so this data item 1120 is emphasized in the same manner (double-lined border). The third detailed data item 1134 is separated from the first two items 1132 with a gap, to indicate that it is not associated with the same first category item 1120. Instead, this third detailed data item 1134 is associated with the second of the first category data items 1122. To show this association, both of these items are emphasized similarly (bolded, dashed border). Note that the visual association between records in the first column 122 and the third column 126 doesn't need to be indicated by changing the style of border, as other types of visual associations are possible. For instance, related records could be filled with similar colors, or connected with physical lines, etc. FIG. 11 merely indicates that some visual connection showing this association can be provided.

Interface 1200 of FIG. 12 is similar to interface 1100, except that the interface elements 1210, 1220 that select the content of the second column 124 are no longer found within the separate records found in the first column 122. This avoids repetitive presentation of the same user interface elements, although this removal prevents a single click from simultaneously selecting both a new first category item in column one 122 and the content of the second column 124.

As shown in FIGS. 5, 8, and 10, the disclosed embodiments allow the displayed detail data items 210 to be filtered against a record or records from only a single category 220, 230/232, or 240. Similarly, FIGS. 6, 7, and 9 show that the filtering can combine selected record(s) from the first category 220 along with selected record(s) from the second 230/232 or third 240 categories. The previous description also disclosed that the displayed detail records 210 can be unfiltered altogether.

### Interfaces Using the Example Data Organizations

FIG. 13 shows an interface 1300 that is very similar to interface 700 shown in FIG. 7, except that the generic data organization 200 has been replaced with the medical data organization 300. In interface 1300, the first column 122 contains records 1320 identifying different patients 320, with June Clark's record 1322 being selected. Two user interface elements 1310 and 1312 are presented to allow the user to determine whether the second column 124 contains information about medical conditions 330/332 or caregivers 340, respectively. In interface 1300, interface element 1310 has been selected, indicating that the second column 124 allows the user to filter based on medical condition. The data 1330 shown in this column includes medical areas 332 and medical conditions 330 in a parent/child relationship. The medical condition record 1332 for “Kidney Stones” has been selected, as shown by the bolded outline for this record in interface 1300. The detailed records 1340 contain medical updates, in this case only those medical updates related to June Clark's kidney stones. This filtering is determined by the selected records 1322 and 1332, and is clarified by the title 1350 appearing above the medical update detail records 1340 shown in the third column 126.

Note that second column 124 identifies three child conditions 330 of the Genito-Urinary medical area 332, namely Kidney Stones 1332, Urinary Retention 1334, and UTI 1336. The labels for the Kidney Stones 1332 and UTI 1336 record start with a circle (“•”). The circle is used as a secondary indicator relating to both Kidney Stones 1332 and UTI 1336 for June Clark 1322. In one embodiment, this circle indicates that a record of this type is active for this patient. In the medical context, an active record indicates a condition that is being discussed or monitored by caregivers and has not yet been resolved. For example, the circle on FIG. 13 indicates that June Clark 1322 has an ongoing issue with kidney stones. Once this issue is resolved, the circle will no longer be present on element 1332. In other embodiments, the circle may indicate that detail records 1340 exist for the selected patent June Clark 1322 associated these medical conditions 1332 and 1336 (whether or not the condition is “active”). There is no circle in front of the label for Urinary Retention 1334, which indicates that no medical update records 1340 exist for June Clark for this medical condition. The circle acts as a visual indicator so that the user will know which of the medical conditions records 330/332 will be relevant to the selected patient record 320. Other types of visual indicators could also be used for this purpose. Alternatively, rather than using the visual indicator in the second column 124, the second column 124 itself could be filtered to list only those medical areas 332 and conditions 330 that are relevant to the selected patient record 320 in the first column 122.

If user interface element 1312 is selected, then interface 1300 will be replaced by interface 1400, in which a list 1430 of medical caregiver records 340 are shown in the second column 124. This list 1430 shows three different caregivers, with the first record 1432 for Dr. Smith being selected. In one embodiment, the list of caregivers 1430 presented in the second column 124 will vary depending upon which patient record 320 in the list 1320 is selected in the first column 122. Ideally, only caregiver records 340 that are related to detail medical update records 310 that are in turn related to the selected patient record 320 will be presented. In other words, once June Clark's record 1322 is selected, only caregivers that have provided medical update records 310 for June Clark will be shown. There is no need to show the caregiver record for Dr. Jones if Dr. Jones has not authored any update records for June Clark. If David Jensen is selected as the patient, and Dr. Jones is one of Mr. Jensen's physicians, then the record for Dr. Jones will be included in the caregiver list 1430. In this interface 1400, there is no need to use the circle visual indicator used in interface 1300.

FIG. 15 shows an interface 1500 that is very similar to interfaces 1300 and 700, but in which the legal data organization 400 is being used. The first column 122 contains client data records 1520, with the Jumbo Corp. record 1522 being the selected client 420. The second column 124 contains types of actions 430 and types of matters 432 in a hierarchical arrangement 1530. In this case, the patent applications record 1532 is selected. The detail records 1540 in the third column contain docket data 410. In particular, the third column contains docket data related to office actions for the Jumbo Corp., as indicated by title 1542

### Alternative Interfaces

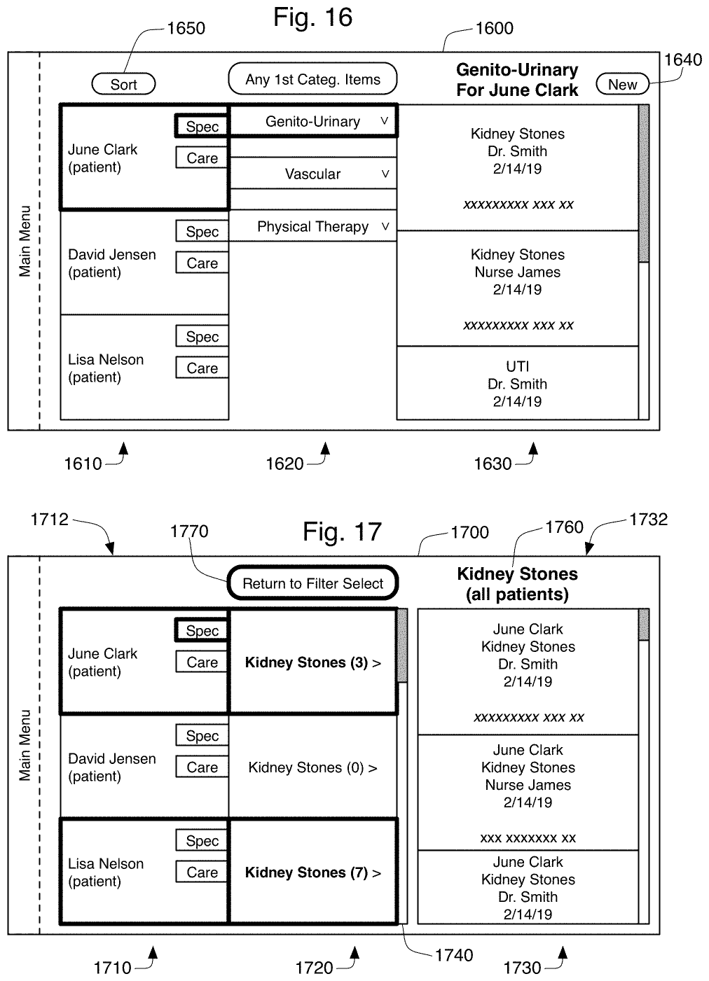

FIG. 16 shows an alternative user interface 1600. This interface 1600 differs from the interfaces shown in FIGS. 5 through 15 in that no space is shown between the three columns 1610, 1620, and 1630. On the smaller devices provided by smart phones, this condensed form of the three-column interface is frequently preferable.

This interface 1600 also contains a new button 1640 that allows the user to create a new detail record (in this case a medical update 310). The creation of the new record 310 will use standard user interface elements to allow the selection of data fields and the entry of field contents for the new record 310. The associations between the new medical update record 310 and the patient 320, caregiver 340, and condition 330 can be determined by either user settings, preferences, or current filter settings, or a combination of these sources. If the user is a caregiver assigned to a patient record that the user already selected (e.g., the user might be Dr. Smith reviewing records for her patient June Clark), then the new medical update record 310 will be assigned to the patient record 320 for June Clark and to the caregiver record 340 for Dr. Smith. If the filter in the second column 1620 relates to a particular medical specialty 332, the relation to that record 332 can be determined by that filter. Alternatively, the user settings for Dr. Smith may indicate that all new medical update records 310 are assigned to the Kidney Stones condition 330. It is also possible that the user interface that accepts data for new medical update records 310 will ask the user to assign the appropriate condition record 330.

Interface 1600 also contains a sort button 1650. As explained above, this type of user interface element allows the user to sort the records in a particular row. The sorting of items, and the selection of the sort criteria, can be accomplished in the same manner that it is accomplished in prior art data systems.

FIG. 17 shows interface 1700, which like interface 1600 contains no space between the first and second columns 1710 and 1720. This interface does, however, contain a space between the second column 1720 and the third column 1730. Adjacent this space is a scroll bar 1740. In this interface 1700, the user has selected to see medical updates 1732 that relate to Kidney Stones but don't relate to any particular patient, as shown by title 1760. Because the selection of these elements is made clear by this title 1760, the second column 1720 does not need to continue to show the list of all conditions and medical areas 330, 332. In this interface 1700, the second column 1720 is instead used to indicate how many of the detail records 1732 are associated with each of the patient records 1712 in the first column 1710. In FIG. 17, three of the detail records 1732 are associated with June Clark, none are associated with David Jensen, and seven are associated with Lisa Nelson. This information is provided in the second column 1720, and each element in the second column is attached to the related data record 1712 in the first column 1710. Consequently, as one navigates the list of patients 1712 using the scroll bar 1740, the number indicators in the second column 1720 will move with this list 1712. Thus, interface 1700 abuts the first two columns 1710, 1720 together with a single scroll bar 1740, and then spatially separates the third column 1730 and its associated scroll bar.

FIG. 18 shows an interface 1800 in which the content of the first column 1810 is not fixed to the first category of data 220. In this interface, the main menu 1802 provides an interface element 1804 that allows the user to select the content for the first column 1810. This interface element 1804 could open a new selection interface, could be a button that simply changes the content of the first column 1810, or could present a drop down menu of available date items for the first column 1810.

This interface 1800 is visually similar to interface 600 of FIG. 6, except that the third category records 240 are presented in the list 1812 in the first column 1810, while the first category records 220 are presented in the list 1822 shown in the second column 1820. As explained above, it is generally preferable that a single type of data appear in the first column of the interface, such as the patient information 320 in the medical data organization 300 or the client information 420 in the legal data organization 400. But sometimes it is important, for instance, for an attorney 440 to see all of their docket items organized by type of action 430 (such as all upcoming office action responses for an attorney). If the content of the first column 1810 could not be changed, then it becomes very difficult to filter the detailed docket item records 410 appropriately.

In FIG. 18, the content of the first column 1810 was selected to list 1812 the records from the third category 240, while user interface element 1816 was used to determined that the second column 1820 will include a listing 1822 of relevant first category items 220. User interface element 1818 could have been selected to fill the second column with the second category 230/232 data. In this way, it is possible to filter the relevant detail records displayed 1832 through a combination of the third category data items 240 and the second category data items 230/232.

The main menu 1802 may also contain a user interface element 1806 that allows a user to prefilter all of the detailed data presented. For example, a physician may want to prefilter the data so that only medical updates related to her own patients are presented through the interface 1800. Patient data 320 may be directly related to caregiver records 340 in the medical data organization 300, although this is not shown in FIG. 3. Using this interface element 1806, only the caregiver's own patients and the related detail records 310 would be presented in the interface 1800. Alternatively, in the context of the legal data organization 400, only clients or matters assigned to the attorney in organization 400 will be presented to the attorney when they use interface 1800.

In FIG. 18, a single detail record 1834 is selected. In one embodiment, the selection of a detail record 1834 causes the visual representation of that detail record 1834 to enlarge, as shown in FIG. 19. In this figure, an enlarged detail record 1900 is shown superimposed over the rest of the user interface 1800. This allows the user to easily read and edit the content of this selected detail record 1834 by providing the full screen 110 of the mobile device for this purpose. The enlarged record 1900 can be removed from the interface 1800 by clicking on a “close” button 1910.

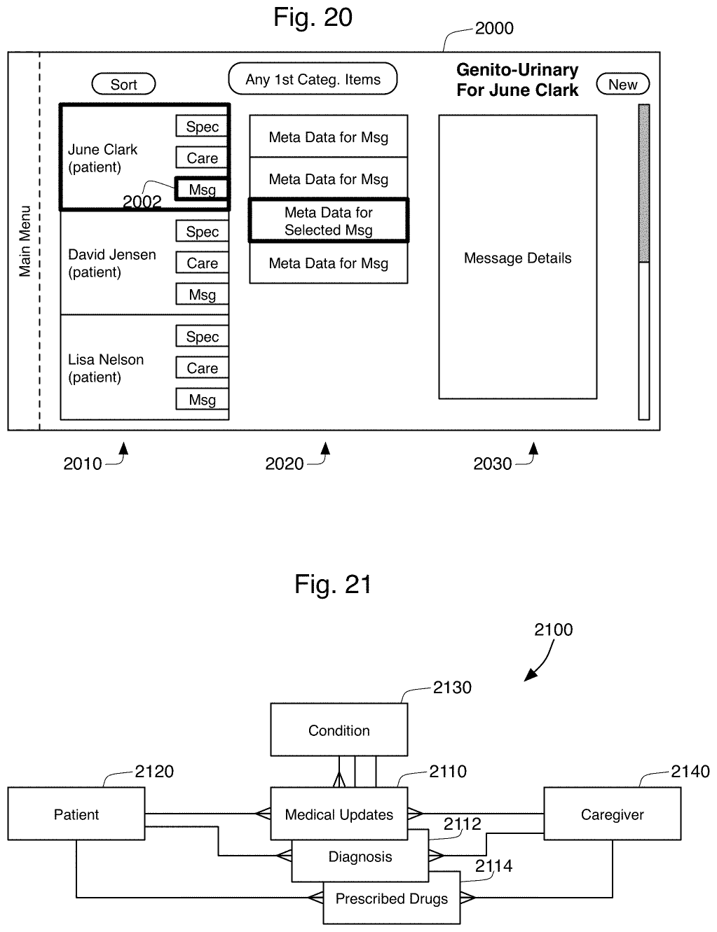

FIG. 20 shows that a three-column interface 2000 can be also used to access information related to a category record 220-240 other than the detail record 210. In this case, the first column contains patient records 320. Rather than reviewing detail records, the user can select to see messages to and from this patient by selecting user interface element 2002 in one of the client records presented in the first column 2010. In this case, the second column would then contain high-level metadata for the various messages related to this patient (such as the date and subject of the message). In the preferred embodiment, these messages would be messages sent between the selected client and the user of the mobile device 100. The user then selects a message from the second column 2020, causing the third column 2030 to show the content for the selected message.

FIG. 21 shows an alternative data organization 2100 related to the medical data organization 300 of FIG. 3. Like organization 300, the detail records 2110 constitute medical updates 2110, and they are related to a patient 2120, a condition 2130, and a caregiver 2140. In this data organization 2100, however, two additional types of detail data are presented, namely diagnosis detail data records 2112 and prescribed drugs data records 2114. These additional data entities 2112, 2114 constitute detail data records in the same manner as the medical update records 2110. All of the detail record types 2110, 2112, 2114 are each associated with a patient category record 2120, a condition (being diagnosed or treated) 2130, and a caregiver 2140.

When multiple detail records 2110, 2112, 2114 are present in the data organization 2100, the user interface can present a menu option that allows the user to select the type of detail data to be viewed. For instance, interface 1400 of FIG. 14 could be used for any of the detail records 2110, 2112, and 2114. The user could select a patient record 2120 and a caregiver 2140, in the first and second column 122, 124, respectively. The detail records in the third column 126 could then vary between the medical updates 2110 (as shown in FIG. 14) and diagnosis 2112 and prescribed medications 2114, depending on the detail records 2110, 2112, 2114 selected by the user. In other words, the three-column interface embodiments described above can be enhanced by allowing the user to select among a variety of available detail records 2110, 2112, 2114 for the third column 126 of the interface.

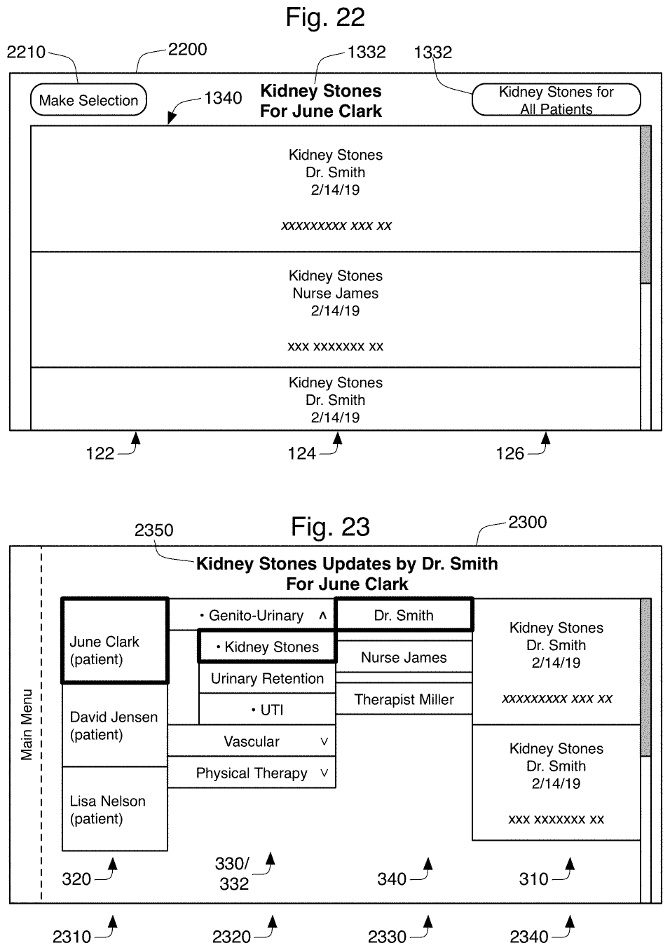

FIG. 22 shows an alternative interface 2200 to the enlarged selected detail record 1900 of FIG. 19. In this interface 2200, all of the detail records 1340 from FIG. 13 are shown expanded across all three columns 122, 124, and 126. This expanded view allows the user a better ability to identify and examine relevant detail records 1340. The explanation 1350 of the detail records shown (“Kidney Stones for June Clark”) now takes a prominent place at the top center of the interface 2200. It is possible to cover columns 122 and 124 because the explanation 1350 provides all the information needed for the user to identify which detail records 1340 are being viewed. If the user wishes to change the selection of detail records, they can press button 2210 to return to interface 1300 and make a new selection of detail records. The “apply to all patients” button 1360 is still presented in this interface, although the text of the button 1360 now reminds the user that pressing the button will show detail records related to kidney stones for all patients. Once this button 1360 pressed, the displayed detail records 1340 and the descriptive title 1350 for this records 1340 will be updated.

FIG. 23 modifies the three-column interface 120 described above with a fourth column, resulting in an interface 2300 with a first column 2310, a second column 2320, a third column 2330, and a fourth column 2340. This interface allows all three categories of data 320, 330/332, and 340 to be simultaneous displayed on the interface 2300 along with the detail records 310. A four-column interface 2300 has the benefit of allowing a user to simultaneously use three different categories 320, 330/332, 340 to select the detail records 310. Similarly, a five-column interface (not shown) could allow a user to use four categories to select detail records. The problem with four and five-column interfaces is that the small interface screen 110 of mobile device 100 has difficulty in presenting this many columns of data. Thus, while the addition of a fourth column to the described three-column interface 120 is contemplated as part of the present invention, it is not generally preferred.

### Method

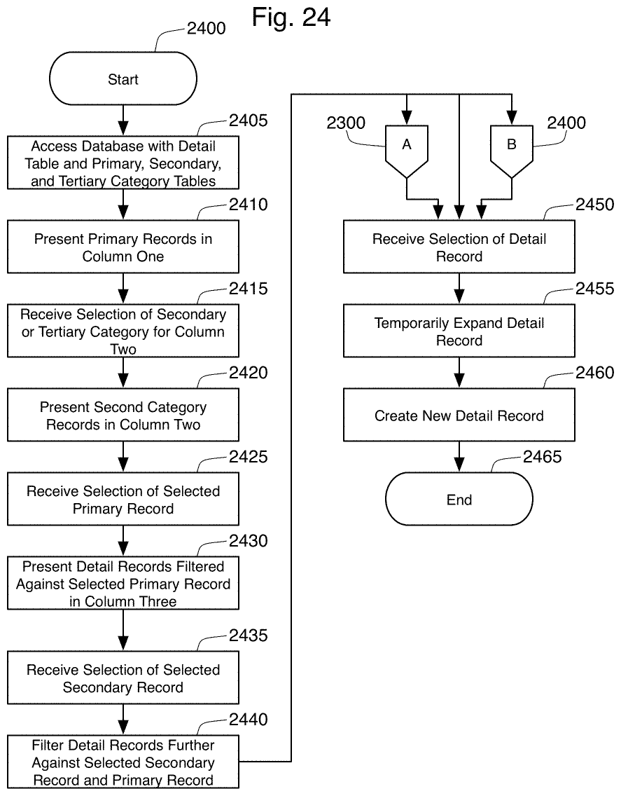

FIG. 24 presents a flow chart for a method 2400 for presenting data in a three-column user interface. The method starts at step 2405 by accessing a database 150 having the necessary organization of data. The organization requires the presence of detail records that are simultaneously associated with (at least) three different data entities that constitute the first (or primary), second (secondary), and third (tertiary) category tables. The data organizations shown in FIGS. 2, 3, 4, and 21 show examples of this organization.

At step 2410, data records from the primary category table are presented in a three-column interface as a list in the first column. As explained above, the user can be given the option to select which category table will serve as the primary category table in the first column.

At step 2415, options are presented to the user to select whether the secondary or tertiary category table be used in the second column to filter the detail records. This ability to choose the second column can be provided through user through interface elements 542, 544, 1210, 1220, 1816, or 1818. The user makes their selection as part of this step 2415. In flow chart 2400, this selected category is described as the second category. At step 2420, records from the second category are presented in the second column of the three-column interface.

At step 2425, the user selects one of the primary records from the first column of the interface. At step 2430, detail records are presented in the third column of the three-column interface. The presented detail records are filtered against the selected primary record from step 2420, so that only detail records related to the selected primary record are shown. In some embodiments, the selection of one of the primary records at step 2425 will also filter the records from the second category that are presented in the second column, so that only options relevant to the selected primary record are presented in the second column. In other embodiments, a visual indicator is used to indicate which entries in the second column are relevant to the selected primary record.

At step 2435, the user will select one of the secondary data records from the second column of the interface. This action will reduce the number of detail records presented in the third column, as these records are now filtered against both the selected primary record and the selected secondary record (step 2440).

At this point, the flow chart allows for several paths as shown in FIG. 24. Note that the presence of multiple paths at this point of the flow chart does not prevent the possibility of multiple paths at different locations in method 2400. It is not necessary that the steps set forth in FIG. 24 are performed exactly in the order presented. For instance, the presentation of detail records could have begun at the same time as step 2410 and before the selection of the secondary category and before the selection of the selected primary record. If detail records were shown at step 2410, these would not be filtered against any particular category record (although they may be prefiltered as described above). Furthermore, the presentation of three separate paths in FIG. 24 after step 2440 does not mean that these options are mutually exclusive.

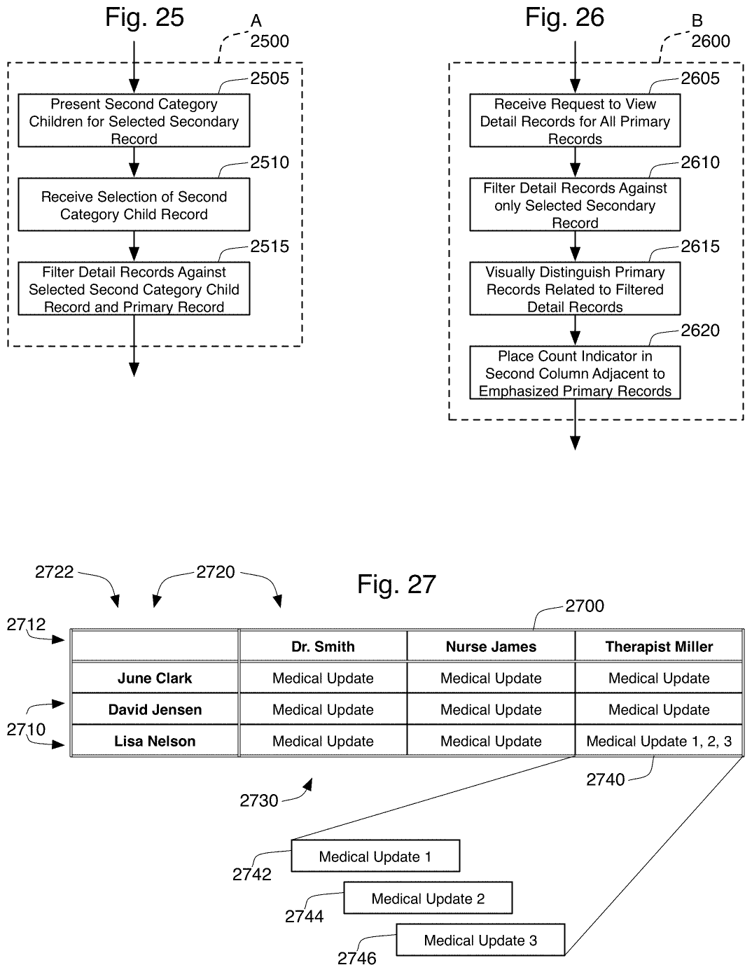

The first option after step 2440 is option A 2500, which is described in more detail in connection with FIG. 25 below. The third option is option B 2600, which is described in connection with FIG. 26. The second option continues to step 2450, in which the user selects a detail record from the third column of the interface. This action then causes the temporary enlargement of this record at step 2455 in order to allow easier review of the contents of the detail record. This is described above in connection with FIG. 19.

At step 2460, the user is given the opportunity to create a new detail record. The options available for the creation of this new record, and the automatic relationships created to other data records, are described above in connection with FIG. 16. The method 2400 then ends at step 2465.

Option A 2500 is shown in FIG. 25 and comprises three steps. This option relates to the manipulation of the second column where the displayed category data includes parent and child records in a hierarchical organization, as shown and described above in connection with FIGS. 6 and 7. The first step 2505 of option A requires the presentation of children records in the second column for a selected secondary record. In other words, a user may select a parent record, and this step 2505 will respond by displaying children records. As explained previously, the control over displaying children records can be provided through a carat interface. At step 2510, the user selects one of the displayed child records. In response, the displayed detail records will again be altered, with the detail records being filtered against the selected primary record and the selected secondary child record. At this point, the flow of option A 2500 returns to step 2450 of FIG. 24.

Option B 2600 is shown in FIG. 26 and relates to the ability to remove filtering of the detail records based on the primary records. This is described above in connection with FIGS. 10 and 11. The first step 2605 of Option B 2600 is to receive a request to view detail records for all of the primary records. This request could be received, for instance, by selecting button 950. At step 2610, the detailed records shown in the third column are modified so that they are filtered only against the selected secondary record and not the selected primary record. Step 2615 requires that the primary records related to the displayed detail records be visually distinguished or otherwise identified, as discussed above in connection with FIG. 11. Step 2620 then places a count indicator in the second column, as described above in connection with FIG. 17. At this point, the flow of option B 2600 returns to step 2450 of FIG. 24.

### Spreadsheet Comparison

The above description describes three-column displays 120 in connection with particular data organizations such as those shown in FIGS. 2, 3, 4, and 21. One can also consider the described three-column display as a means to improve the presentation of data that is stored in a traditional spreadsheet (or flat-file database). FIG. 27 shows a traditional spreadsheet interface 2700 that contains rows 2710 and columns 2720. The first column 2722 of the spreadsheet 2700 is a header column that provides the header for each row 2710. The first row 2712 contains the headers for each column 2720 of the spreadsheet. Based on this header information 2712, 2722, it is clear that the rows represent patient data 320 while the columns represent caregiver data 340. The cells 2730 at the intersections of the rows 2710 and columns 2710 contain the medical update detail data 310.

The three-column display 120 can be considered an improved mechanism to display the content of spreadsheet 2700. As shown in FIG. 14, the first column 122 shows the row heading information 2722, the second column 124 shows the column heading information 2712, and the third column 126 shows the detail medical update information found in the cells 2730. This three-column interface 1400 has numerous advantages over the traditional spreadsheet 2700, including all of the benefits previously described. This interface 1400 simplifies the review and selection of category information, and allows this to happen in a much small user interface screen 110. In addition, as shown in FIG. 13, a three-column interface 1300 can implement a hierarchy for category information 1330, which is not possible in the spreadsheet interface of 2700.

As explained above, it is also difficult to develop a spreadsheet where more than one value or record can appear at the same row and column intersection. This is easily handled in the three-column interface 1400, where a single caregiver is able to create multiple medical updates for a single patient. These different detail records 1440 can be viewed together and sorted however desired (such as chronologically or by any other characteristic). This ability of the three-column interface 1400 effectively adds a new dimension of time (or other characteristic) to the traditional spreadsheet 2700. For example, Therapist Miller could provide three different medical updates 2742, 2744, 2746 for patent Lisa Nelson, which is easy to represent in three-column interface 1400 but presents extreme difficulty in a traditional spreadsheet 2700 that provides only a single cell 2740 for these three update notes.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method comprising:
a) accessing a computerized database containing data having a data organization, the data organization having:
i) detail data having detail records,
ii) first category data having primary records, and
iii) second category data having secondary records,
wherein detail records are related in the data organization to primary records and secondary records;
b) at the first computer, generating a user interface for a mobile device screen comprising a first, second, and third column;
c) at the first computer, listing primary records in the first column;
d) at the first computer, listing secondary records in the second column;
e) at the first computer, listing detail records in the third column;
f) at the first computer, receiving a first input selecting a primary record from the user interface; and
g) at the first computer, after receiving the first input, filtering the listing of detail records so as to limit the listed detail records to detail records related to the selected primary record.

2. The method of claim 1, further comprising, after receiving the first input, changing the listing of secondary records so as to limit the listed secondary records to secondary records related to at least one of the filtered detail records.

3. The method of claim 1, further comprising receiving a second input selecting a secondary record from the user interface, and further, after receiving the second input, filtering the listing of detail records so as to limit the listed detail records to detail records related to both the selected primary record and the selected secondary record.

4. The method of claim 3, further comprising receiving instructions to remove the primary record filtering, and still further changing the listing of detail records so as to list all detail records related to the selected secondary record.

5. The method of claim 4, further comprising presenting in the user interface a visual indicator of the relationship between the listed detail records and the listed primary records.

6. The method of claim 5, further comprising presenting in the user interface counts of the number of listed detail records associated with each of the listed primary records.

7. The method of claim 6, wherein the count is presented in the second column; wherein the listed primary records in the first column are scrolled in the user interface; and further wherein the counts in the second column moves in concert with the listed primary records.

8. The method of claim 3, further comprising receiving a third input selecting a detail record, and further enlarging the selected detail record so as to cover at least a portion of the first, second, and third columns.

9. The method of claim 3, wherein the secondary records comprise parent and child records, and wherein the listing of secondary records comprises listing parent records while providing interface elements to show child records of the parent records.

10. The method of claim 3, wherein the first input comprises selecting a plurality of primary records, and further wherein the filtering of the listing of detail records comprises listing detail records related to any of the plurality of selected primary records.

11. The method of claim 3, wherein the data organization further comprises third category data having tertiary records, further wherein the detail records are further related in the data organization to tertiary records, and further comprising providing a selection mechanism through the user interface to select one of the second category data and third category data for presentation in the second column.

12. The method of claim 11, further comprising:
i) receiving through the selection mechanism a fourth input selecting the third category data,
ii) removing the listing of the secondary records from the second column,
iii) listing tertiary records in the second column, and
iv) filtering the listed detail records only against the selected primary record so as to limit the listed detail records to detail records related to the selected primary record.

13. The method of claim 12, further comprising receiving a fifth input of a selected tertiary record from the user interface, and further, after receiving the fifth input, filtering the listing of detail records so as to limit the listed detail records to detail records related to both the selected primary record and the selected tertiary record.

14. The method of claim 11, wherein the user interface provides the ability for the user to select the detail data from a plurality of detail data types, wherein each of the detail data types are associated in the data organization with first category data, second category data, and third category data.

15. The method of claim 3, wherein the data comprises medical data, and further wherein the first category data is patient data and second category data is caregiver data.

16. The method of claim 3, wherein the data comprises medical data, and further wherein the first category data is patient data and second category data is medical condition data arranged in a hierarchy of parent and child records.

17. The method of claim 3, wherein the data comprises medical data, and further wherein the detail data is selected from a set comprising medical update data, diagnosis data, and prescription data.

18. The method of claim 3, wherein the user interface provides the ability for the user to prefilter the presented data.

19. The method of claim 1, wherein the first column is presented left-most in the user interface, the third column is presented right-most in the user interface, and the second column is presented between the first and third columns.

20. A system comprising:
a) a computerized database containing data having a data organization, the data organization having detail data, first category data, and second category data;
b) a mobile device having a display;
c) a server computer in communication with the computerized database and the mobile device, the server computer having:
i) a processing unit that responds to programming instructions, and
ii) a memory;
d) programming instructions in the memory of the server computer causing the processing unit to:
i) generate a user interface for the display of the mobile device, the user interface comprising a first, second, and third column;
ii) list first records from the first category data in the first column;
iii) list second records from the second category data in the second column;
iv) receive a first selection of a selected first record from the first column of the user interface;
v) receive a second selection of a selected second record from the second column of the user interface; and
vi) list detail records filtered against the selected primary record and the selected secondary record in the third column.
